(19) United States
(12) Patent Application Publication
(10) Pub. No.: US 2007/0132737 A1
(43) Pub. Date: Jun. 14, 2007

(54) Systems and methods for determining touch location

(76) Inventors: Roger C. Mulligan, Surrey (CA); Massoud S. Badaye, Vancouver (CA)

Correspondence Address: 3M INNOVATIVE PROPERTIES COMPANY, PO BOX 33427, ST. PAUL, MN, 55133-3427, US

(21) Appl. No.: 11/298,969

(22) Filed: Dec. 9, 2005

(51) Int. Cl. G09G 5/00

(52) U.S. Cl. 345/173

(57) ABSTRACT

A touch panel includes first and second layers of electrodes. The first layer of electrodes is electrically connected in an arrangement that produces a regional ambiguity in a touch location determined using the first electrodes with respect to a first axis. The second layer of electrodes is configured to resolve the regional ambiguity of the touch location with respect to the first axis. Conversely, the second layer of electrodes may also be connected in an arrangement that creates regional ambiguity in touch location determination of the second layer, and the first layer of electrodes may be configured to resolve that regional ambiguity.

The present invention relates to methods and systems for determining the location of a touch in proximity with a touch surface.

### BACKGROUND

Interactive electronic displays are widely used. In the past, use of interactive electronic displays has been primarily limited to computing applications, such as desktop computers and notebook computers. As processing power has become more readily available, electronic displays are being integrated into a wide variety of applications. For example, it is now common to see interactive electronic displays in applications such as teller machines, gaming machines, automotive navigation systems, restaurant management systems, grocery store checkout lines, gas pumps, information kiosks, and hand-held data organizers, to name a few.

Interactive displays often include some form of touch sensitive screen. Integrating touch sensitive panels with visual displays is becoming more common with the emergence of portable multimedia devices. Capacitive touch sensing techniques for touch sensitive panels involve sensing a change in a signal due to capacitive coupling created by a touch on the touch panel. An electric field is applied to electrodes on the touch panel. A touch on the touch panel capacitively couples with the electrodes, altering the electric field in the vicinity of the touch. The change in the field is detected and used to determine the touch location. Increasing the accuracy and/or decreasing the processing time of touch location determination is desirable.

### SUMMARY OF THE INVENTION

The present invention is directed to touch sensing systems and methods. Embodiments of the present invention are directed to a touch system comprising a touch panel. A first layer of one or more first electrodes of the touch panel are electrically connected in an arrangement that produces a regional ambiguity in a touch location determined using the first electrodes with respect to a first axis. A second layer of one or more second electrodes of the touch panel are configured to resolve the regional ambiguity of the touch location with respect to the first axis.

According to one aspect of the invention, the first electrodes are configured to be predominantly responsive to the touch location with respect to the first axis and less dominantly responsive to the touch location with respect to a second axis. The second electrodes are configured to be predominantly responsive to the touch location with respect to the second axis and less dominantly responsive to the touch location with respect to the first axis.

In one configuration, the first electrodes comprise a first layer of substantially parallel electrodes and the second electrodes comprise a second layer of substantially parallel electrodes. The longitudinal axis of the first electrodes may be substantially perpendicular to a longitudinal axis of the second electrodes. One or both of the first electrodes and the second electrodes may involve substantially parallel electrodes electrically connected in a repeating pattern, a discrete pattern, or a non-discrete pattern.

In another configuration, the second electrodes comprise a single electrode sheet and the first electrodes comprise a layer of substantially parallel electrodes.

According to another aspect of the invention, the arrangement of the first electrodes allows determination of the touch location using a non-ratiometric process and the arrangement of the second electrodes allows resolution of the regional ambiguity using a ratiometric process.

The second electrodes may be electrically connected in an arrangement that produces a regional ambiguity in a touch location determined using the second electrodes with respect to a second axis. The first electrodes are configured to resolve the regional ambiguity of the touch location with respect to the second axis.

The touch system may further include a controller connected to the first and second electrodes. The controller uses touch signals generated by the first electrodes to determine the touch location with respect to a first axis and uses the touch signals generated by the second electrodes to resolve the regional ambiguity with respect to the first axis. The touch system may also include a display that is viewable through the touch panel.

Another embodiment involves a method for touch location determination. A touch location having a regional ambiguity with respect to a first axis of a touch panel is determined using touch signals generated by one or more first electrodes. The first axis regional ambiguity is resolved using touch signals generated by one or more second electrodes.

In one implementation, the touch signals generated by the first electrodes are predominantly responsive to the touch location with respect to a first axis and are less dominantly responsive to the touch location with respect to a second axis. The touch signals generated by the second electrodes are predominantly responsive to the touch location with respect to the second axis and are less dominantly responsive to the touch location with respect to the first axis. The first electrodes may be disposed in a first layer of the touch panel and the second electrodes disposed in a second layer of the touch panel.

The method may further involve determining the touch location having a regional ambiguity with respect to a second axis of the touch panel using touch signals generated by the second layer of one or more second electrodes. The second axis regional ambiguity is resolved using touch signals generated by the first layer of one or more first electrodes.

The touch location may be determined using non-ratiometric touch signals generated by the first electrodes. The first axis ambiguity in the touch location may be resolved using ratiometric touch signals generated by the second electrodes.

In various implementations, the touch location is determined using touch signals generated by the electrodes which are electrically connected in a discrete, non-discrete pattern, or repeating pattern.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1 is a flowchart illustrating a method of touch location determination using location estimation for multilayer electrode touch systems in accordance with embodiments of the invention;

FIGS. 2A-D illustrate an electrode configuration using a repeating pattern of top and bottom electrodes which may be used to determine touch location in accordance with embodiments of the invention;

FIG. 3 provides a graphical representation of a characteristic signal pattern caused by a touch in the vicinity of three adjacent electrodes which may be utilized for touch location determination in accordance with embodiments of the invention;

FIG. 4 illustrates a touch panel using a simple coded pattern to connect electrodes to signal lines which may be used to implement touch location determination processes in accordance with an embodiment of the invention;

FIG. 5 illustrates a touch panel using two electrode layers having electrodes that alternate between wider and narrower sections and which may be used in conjunction with touch location processes in accordance with embodiments of the invention;

FIGS. 6A-C illustrate touch panel configurations including an electrode array layer and a planar electrode layer which may be used for touch location determination in accordance with embodiments of the invention;

FIGS. 7A-B illustrates a touch panel configuration having a planar electrode that may be used to estimate the touch location in accordance with embodiments of the invention;

FIG. 8 illustrates a touch sensing system that incorporates a touch sensor which provides for gain and/or offset calibration on a per-sense channel basis in accordance with the principles of the present invention.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF VARIOUS EMBODIMENTS

In the following description of the illustrated embodiments, reference is made to the accompanying drawings that form a part hereof, and in which is shown by way of illustration, various embodiments in which the invention may be practiced. It is to be understood that the embodiments may be utilized and structural changes may be made without departing from the scope of the present invention.

In various implementations, capacitive touch sensors may include multiple layers of electrodes, such as substantially parallel electrodes, or may include a first layer of electrodes with a planar electrode disposed on a second layer, or may include other electrode configurations. Touch sensing involves detecting changes in electrical signals present at the electrodes in the vicinity of a touch. In some implementations, the touch sensor may use a first layer of parallel electrodes to sense the touch location in the Y-direction and a second layer of parallel electrodes, arranged orthogonally to the first layer electrodes, to detect the touch location in the X-direction. The X and Y electrodes are driven with an electrical signal generated by controller electronics. A touch to or near the touch surface capacitively couples X and Y electrodes in the vicinity of the touch to ground. The capacitive coupling causes a change in the electrical signal on the electrodes near the touch location. The amount of capacitive coupling to each electrode, and, thus the change in the signal on the electrode varies with the distance between the electrode and the touch. Controller electronics determines the coordinates of the touch location by examining the changes in the electrical signals detectable on the X and Y electrodes.

The X and Y electrodes are connected to the controller electronics through signal lines. As the surface area and desired resolution of touch panels increases, the number of signal lines needed to individually couple the X and Y electrodes to the controller becomes excessive. Embodiments of the invention are directed to systems and methods for reducing the number and/or complexity of signal line connections while maintaining or enhancing touch system surface area and resolution

Embodiments of invention are directed to touch sensing systems that use one or more first electrodes to determine the touch location with respect to a first axis and one or more second electrodes to determine the touch location with respect to a second axis. The first and second electrodes may be disposed on separate layers of the touch panel. The first electrodes may be configured to be predominantly responsive to the touch location with respect to a first axis, e.g., the Y axis, and less responsive to the touch location with respect to a second axis, e.g., the X axis. The second electrodes may be configured to be predominantly responsive to the touch location with respect to the second axis and less responsive to the touch location with respect to the first axis. The first and second axes may be, but need not be, substantially orthogonal. It will be understood that a touch may occur when physical contact is made between a conductive object such as a finger or stylus and the surface of the touch panel. A touch may also occur if the conductive object is sufficiently close to the touch surface to produce an amount of capacitive coupling detectable as a touch.

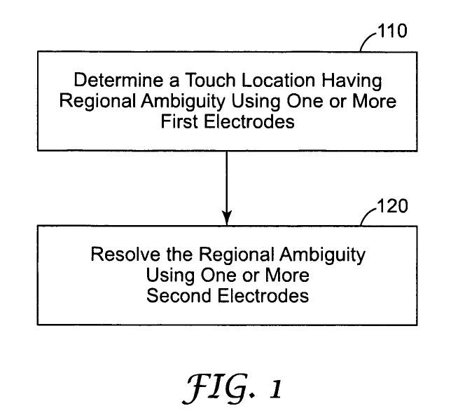

FIG. 1 is a flowchart illustrating a method of touch location determination for multilayer electrode touch systems in accordance with embodiments of the invention. A touch location having a regional ambiguity with respect to an axis is determined 110 using touch signals generated by one or more first electrodes in response to a touch. The regional ambiguity with respect to the axis is resolved 120 using touch signals generated by one or more second electrodes responsive to the touch.

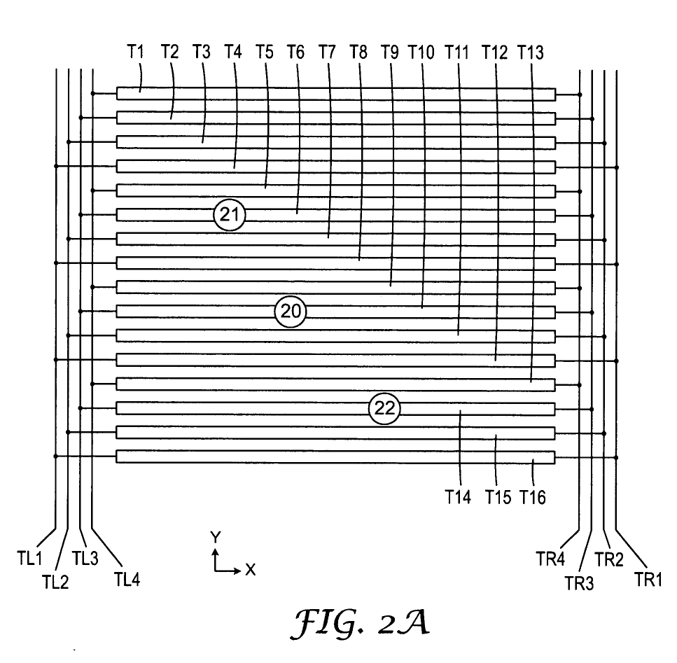

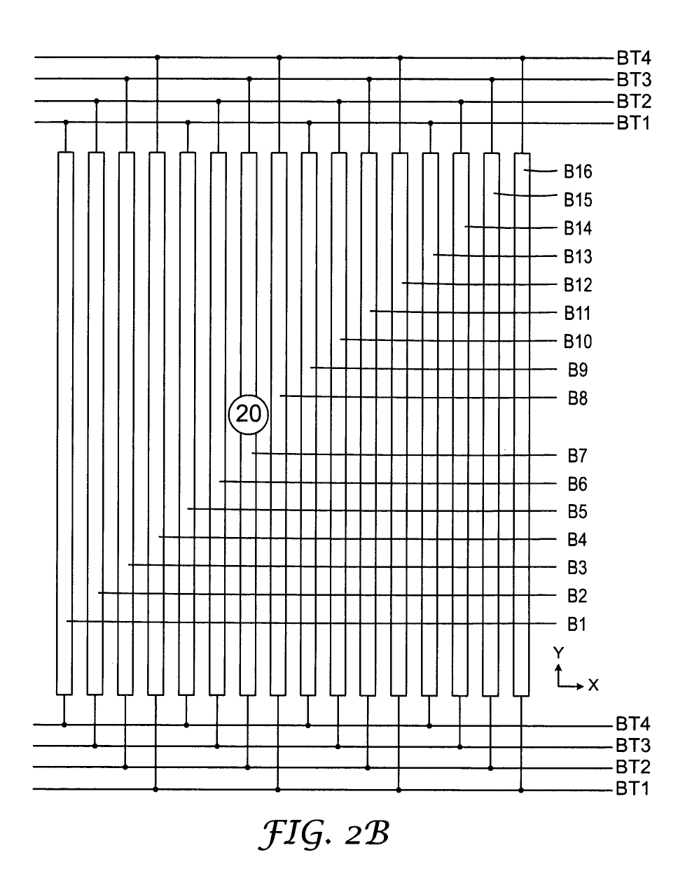

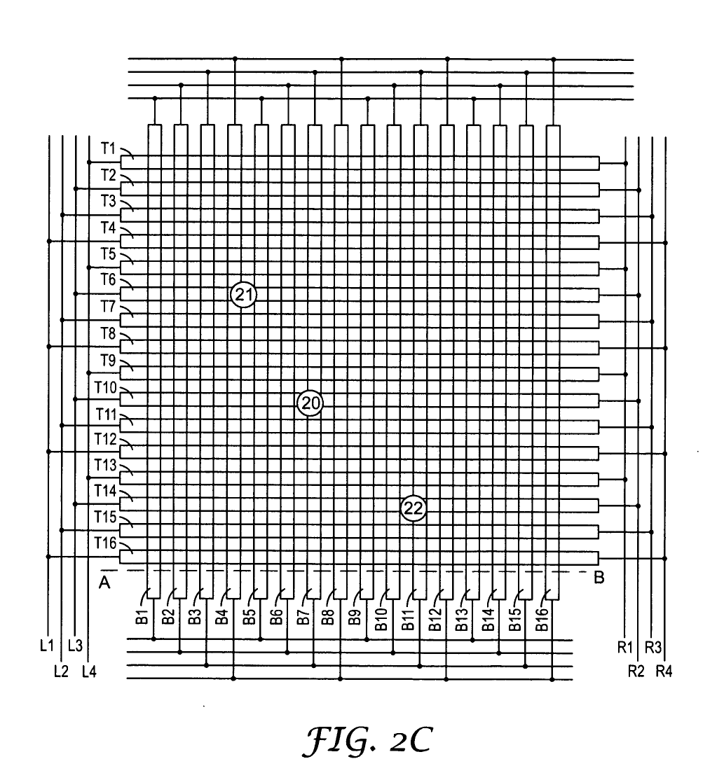

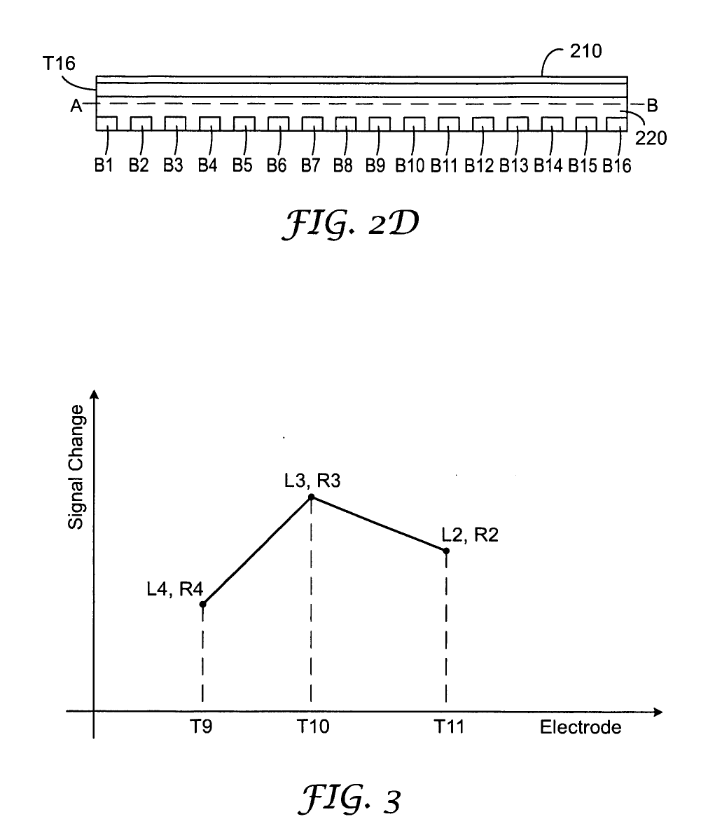

The method of touch location determination described in connection with FIG. 1 may be implemented using a touch panel configured as illustrated in FIGS. 2A-D. FIGS. 2A and 2B illustrate top and bottom electrode layers, respectively, of a touch panel. FIG. 2C illustrates the arrangement of top and bottom electrode layers in a substantially orthogonal orientation.

FIG. 2D illustrates a cross section of the touch panel illustrating touch surface 210, which may comprise multiple layers, representative top electrode T16, and bottom electrodes B1-B16. The top surface may be glass, such as chemically strengthened or tempered glass, or another transparent material. In applications where optical transparency is unnecessary, any suitable material may be used, such as plastic or other non-conductive material. In some applications, it may be desirable to make a flexible touch sensor. In these applications, the touch surface may be made from a flexible material, such as polyester.

The top and bottom electrodes T16, B1-B16 are separated by a dielectric material. For transparent touch screens, the electrodes T16, B1-B16 may be formed of a transparent conductive material, such as indium tin oxide (ITO) or other transparent conductor. ITO may be deposited on a transparent substrate, such as glass or polyethylene terapthalate (PET). For applications that do not require transparency, electrodes may be made of metal or other conductive materials. Transparent touch screens are often used in conjunction with a display that is viewable through the touch screen.

The top electrode layer illustrated in FIGS. 2A and 2C is predominantly responsive to touch location with respect to the Y axis and is used to determine the touch location with respect to the Y axis. The bottom electrode layer illustrated in FIGS. 2B and 2Cis predominantly responsive to touch location with respect to the X axis and is used to determine touch location with respect to the X axis.

The top electrode layer illustrated in FIGS. 2A and 2C comprises 16 substantially parallel electrodes T1-T16, where the longitudinal axes of the electrodes T1-T16 are arranged approximately in the X direction. The left ends of top layer electrodes T1-T16 are connected to signal lines of a controller (not shown) in a repeating pattern via signal lines TL1, TL2, TL3, TL4. The right ends of top layer electrodes T1-T16 are also connected to the signal lines of the controller in a repeating pattern via signal lines TR1, TR2, TR3, TR4. The repeating pattern of the left end connections TL1, TL2, TL3, TL4 to signal lines of the controller exhibits mirror image symmetry with respect to the repeating pattern of the right end connections TR1, TR2, TR3, TR4 to signal lines of the controller, i.e., the top most electrode T1 is connected to signal line TL4 at the left end and to signal line TR4 at the right end. In a typical implementation, all the signal lines are connected to the controller electronics through a cable running from the touch panel to the controller. The connections between electrodes T1-T16 and signal lines TL1-TL4 form a coded pattern as follows: TL1, TL2, TL3, TL4, TL1, TL2, TL3, TL4, TL1, TL2, TL3, TL4, TL1, TL2, TL3, TL4. The connections between electrodes T1-T16 and signal lines TR1-TR4 form a coded pattern as follows: TR1, TR2, TR3, TR4, TR1, TR2, TR3, TR4, TR1, TR2, TR3, TR4, TR1, TR2, TR3, TR4.

The bottom electrode layer illustrated in FIGS. 2B and 2C comprises 16 substantially parallel electrodes B1-B16 having longitudinal axes arranged approximately in the Y direction. The top ends of bottom layer electrodes B1-B16 are connected to the signal lines of the controller (not shown) in a repeating pattern via signal lines BT1, BT2, BT3, BT4. The bottom ends of bottom layer electrodes B1-B16 are connected to the controller in a repeating pattern via signal lines BB1, BB2, BB3, BB4. The repeating pattern of the top end connections to signal lines BT1, BT2, BT3, BT4 exhibits mirror image symmetry with respect to the repeating pattern of the right end connections to signal line BB1, BB2, BB3, BB4. The connections between electrodes B1-B16 and signal lines BT1-BT4 form a coded pattern as follows: The connections between electrodes B1-B16 and signal lines BT1-BT4 form a coded pattern as follows: BT1, BT2, BT3, BT4, BT1, BT2, BT3, BT4, BT1, BT2, BT3, BT4, BT1, BT2, BT3, BT4. The connections between electrodes B1-B16 and signal lines BB1-BB4 form a coded pattern as follows: BB1, BB2, BB3, BB4, BB1, BB2, BB3, BB4, BB1, BB2, BB3, BB4, BB1, BB2, BB3, BB4.

A touch to the touch panel in the vicinity of an electrode T1-T16, B1-B16 will create a signal at least on the electrode nearest the touch and also on adjacent electrodes. The peak of the change will be observed on the electrode closest to the touch, with signals on electrodes farther from the touch exhibiting a lesser amount of change. For example, with respect to the top electrode layer, a touch at point 20 on the touch panel will generate a change primarily in the electrical signal on electrode T10 and secondarily in the electrical signal on electrodes T9 and T11. The peak of the signal change will be experienced by electrode T11, because electrode T10 is closest to the touch and experiences the greatest amount of capacitive coupling. The electrical signal on electrode T11 may be the next most affected because electrode T11 is the next closest electrode to the touch. The electrical signal on electrode T9 will likely experience a lesser degree of change than electrode T11 because electrode T9 is farther from the touch than electrode T11. The controller may determine the touch location with respect to the Y axis as the Y coordinate of T10 and/or may refine the touch location with respect to the Y axis through linear and/or non-linear interpolation of the signals present on T10 and electrodes in the vicinity of T10, including adjacent electrodes T9 and T11.

The immediately preceding paragraph describes a process, applicable to both the top and bottom electrode layers of FIGS. 2A-C, for determining which electrode within a group of electrodes that are closest to the touch based on the signal strength of the electrodes within the group. However, because electrodes T5-T7 and T13-T15 are also connected to signal lines TL2-TL4 and TR2-TR4, touches 21 and 22 will cause similar signal changes on signal lines TL2-TL4 and TR2-TR4. Thus, the repeating pattern of the signal line connections illustrated in FIGS. 2A-C introduces a regional ambiguity with respect to the actual touch location. The repeating pattern of the signal line connections does not allow the controller to completely resolve the touch location with respect to the various groups of electrodes that are connected in a similar pattern to the signal lines. Thus, while the touch location can be accurately resolved as to the location within the groups of electrodes defined by the repeating pattern, the particular group of electrodes affected by the touch cannot be determined by this process.

In accordance with embodiments of the invention, the electrodes on one electrode layer may be used to resolve the regional ambiguity of the touch location determined by another electrode layer. Resolving the regional ambiguity of the touch location provides the controller with sufficient information to determine both the touch location within groups of similarly connected electrodes, and which group of electrodes is closest to the touch. The bottom electrode layer, which in the example of FIGS. 2A-C is predominantly responsive to the touch location with respect to the X axis, may be used to resolve the regional ambiguity of the touch location determined by the top electrode layer with respect to the Y axis. The top electrode layer, which in the example of FIGS. 2A-C is predominantly responsive to the touch location with respect to the Y axis, may be used to resolve the regional ambiguity of the touch location determined by the bottom electrode layer with respect to the X axis.

In accordance with embodiments of the invention, determining the touch location within the groups of electrodes may be based on a non-ratiometric process, and resolving the ambiguity in the touch location determination may be based on a ratiometric measurement of electrical signals on the electrodes of the other layer. As described above, in connection with FIGS. 2A-C, the location of a touch with respect to the Y axis within the groups of electrodes of the top layer may be determined based on the signal lines exhibiting the largest change in the electrical signal responsive to the touch. Information acquired by a ratiometric measurement of touch signals generated by the electrodes of the bottom layer may be used to determine which group of top electrodes is closest to the touch.

Using ratiometric measurements to resolve ambiguity in the touch location may be performed by determining the ratio of the signal responsive to the touch at opposite ends of the affected electrode. A touch at the midpoint of an electrode B1-B16 would be expected to cause an approximately equal change in the signal sensed at top and bottom signal lines BT1-BT4, BB1-BB4. As indicated in FIG. 2B, the electrical signal on electrode B7 will be most strongly affected by touch 20. The estimated touch location with respect to the Y axis may be determined by the ratio of the signals sensed at the top and bottom of electrode B7, i.e., at signal lines BT2 and BB2, respectively. If the material, e.g., ITO, of the bottom electrodes B1-B16 is reasonably linear within the spacing of the repeating pattern of top electrodes T1-T16, then the touch location can be determined as to which particular group of the top electrodes T1-T16 is closest to the touch location.

The preceding paragraphs describe a process for determining the touch location with respect to the Y axis within groups of similarly connected electrodes through evaluation of the relative strength of touch signals generated by top layer electrodes. The ambiguity in the Y axis touch location is resolved using a ratiometric evaluation of touch signals generated by the bottom layer electrodes. A similar approach may be applied to determine the touch location with respect to the X axis. The touch location with respect to the X axis within groups of similarly connected electrodes may be determined through evaluation of the relative strength of touch signals generated by the bottom layer electrodes. The ambiguity in the X axis touch location is resolved using a ratiometric evaluation of touch signals on the bottom top layer electrodes.

Electrode configurations described herein allow an electrode pattern to be repeated on an electrode layer so long as the ITO, or other material comprising the opposing electrode layer, is sufficiently linear so that ratiometric evaluation of signals generated by the opposing electrode layer can resolve the touch location to the particular group of electrodes in the vicinity of the touch. The ITO linearity does not directly affect the touch location accuracy so long as the correct group of electrodes is resolved by the ratiometric process. The ITO linearity requirement is much less stringent when compared to designs that use the ratiometric process to determine, rather than resolve ambiguity in, the touch location. The required ratiometric accuracy for the electrode configurations described above depends on the total number of groups used in the opposite layer. The more groups, the more stringent the accuracy requirements. For example, if there are 20 groups in a sensor, the ratiometric inaccuracy should be less than 2.5%. The number of groups is determined by the screen size. The number of electrodes in each group is determined by the number of available signal lines in the controller, and the optimum electrodes' spacing.

The example provided above in FIGS. 2A-C, is based on a four electrode repeating pattern, however, more or fewer electrodes may be included in the pattern. The pattern illustrated in FIGS. 2A-C is symmetrical with respect to the connections at the opposite ends (i.e., left end and right end, top end and bottom end) of the electrodes. Advantages may be realized by using an asymmetrical pattern wherein the electrode/signal line interconnection pattern on one side of the touch panel is different from the pattern on the other side. An asymmetrical pattern provides additional information with which to resolve the electrode group closest to the touch. In some embodiments, the electrode/signal line interconnections may be arranged such that each group or window of electrodes has unique membership, wherein any given group includes a different set of electrode/signal line connections than any other group. In this configuration, no group reuses the same set of lines as another group. In further embodiments, the electrode/signal line interconnections may not be uniquely coded, but may be distinguishable through analysis of the signal pattern produced by electrodes in the vicinity of a touch.

Touch location determination based on signal pattern analysis relies on the recognition that a touch produces a peak signal on the electrode nearest the touch and weaker signals on electrodes farther from the touch. A graphical representation of a signal pattern caused by touch 20 on electrodes T9, T10, and T11 of FIG. 2A is illustrated in FIG. 3. The peak signal present on electrode T10 which is connected to signal lines L3 and R3. A smaller signal than the signal present on electrode T10 is present on electrode T11, which is connected to signal lines TL2 and TR2. A smaller signal than the signal present on electrode T11 is present on electrode T9, which is connected to signal lines TL4 and TR4.

The signal pattern exhibits a “bump” pattern since the electrodes farther from the touch T9, T11 are less strongly affected by the touch than electrode T10. The characteristic signal pattern of a touch may deviate slightly from that shown in FIG. 3, but a touch generally exhibits the “bump” configuration. For example, it is possible that two electrodes share approximately equal signal magnitude if the touch occurred exactly between the two electrodes. It will be understood that the edges of the touch panel may present special boundary conditions due to the electrodes at the edges having no neighbors on one side. Thus, the characteristic “bump” signal pattern may not occur for a touch close to a panel edge. Touch location determination using any of the above described patterned or coded electrode/signal line arrangements may be enhanced using an estimated touch location.

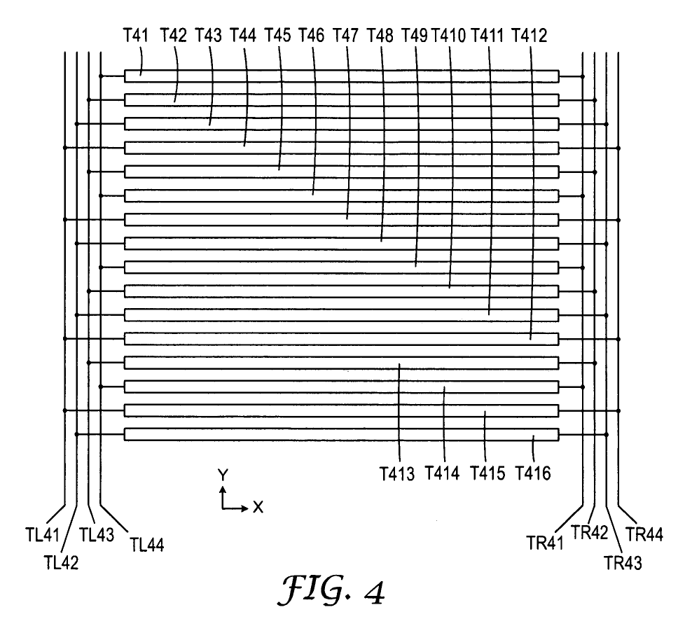

FIG. 4 illustrates the use of a simple pattern to connect electrodes to signal lines in accordance with an embodiment of the invention. The top electrode layer illustrated in FIG. 4 comprises 16 substantially parallel electrodes T41-T416 having longitudinal axes arranged approximately in the X direction. The left ends of top layer electrodes T41-T416 are connected to the controller (not shown) in a repeating, coded pattern via signal lines TL41-TL44. The connections between electrodes T41-T416 and signal lines TL41-TL44 form a pattern as follows: TL41, TL42, TL43, TL44, TL42, TL41, TL44, TL43, TL41, TL42, TL43, TL44, TL42, TL41, TL44, TL43. The connections between electrodes T41-T416 and signal lines TR41-TR44 form a pattern as follows: TR41, TR42, TR43, TR44, TR43, TR41, TR44, TR43, TR41, TR42, TR43, TB44, TR42, TR41, TR44, TR43. The bottom electrode layer of the touch panel may use the same scheme, may use the repeating pattern illustrated in FIG. 2B, or may use another electrode configuration.

As previously described, ambiguities in the touch location with respect to the one axis determined by electrical signals generated by one electrode layer may be resolved based on the ratiometric measurement of electrical signals generated by electrodes of another electrode layer. The controller uses the ratiometric measurement to determine which group of electrodes corresponds to the touch location. The pattern of the electrode configuration of FIG. 4 repeats every 8 electrodes, effectively doubling the size of the electrode group used for determining the touch location. Thus, the required accuracy of the ratiometric touch location estimation is decreased by half when compared to the previous repeating, simple pattern example.

The touch panels illustrated in the above examples comprise rectangular shaped electrodes, although electrodes of any shape may be used. In some configurations, each electrode may comprise two or more electrode elements. For example, each electrode may comprise two elongated triangles, one triangle electrode having an apex oriented to the left side of the touch panel and a signal line connection at the right side of the touch panel, and another triangle electrode having an apex oriented to the right side of the touch panel and a signal line connection at the left side of the touch panel.

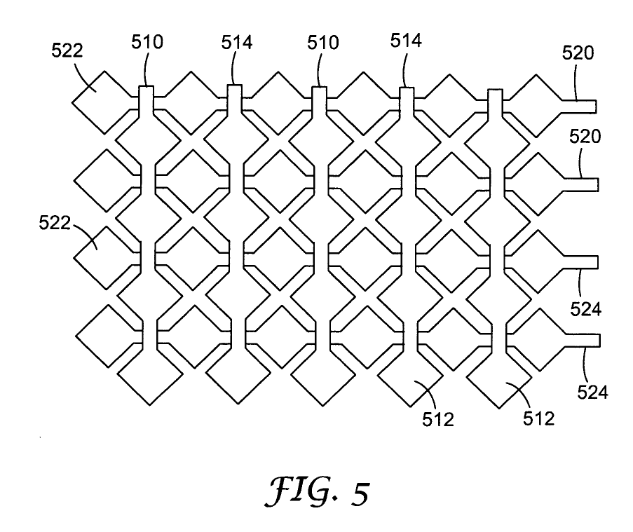

In other configurations, touch panels may be fabricated using two electrode layers having electrodes 510, 520 that alternate between wider 512, 522 and narrower 514, 524 sections, as illustrated in FIG. 5, for example. Such configurations advantageously increase the amount of capacitive coupling to the lower sensing layer, enhancing touch location accuracy with respect to the coordinate resolved by the lower layer. However, construction of this type of touch panel involves careful alignment of the upper and lower sensing layers so that the narrower electrode portions 514, 524 of both layers are perpendicular and centered with respect to each other, and the clearance between the wider portions 512, 522 of both layers remain the same throughout the whole surface of the sensor. For large area touch panels having numerous electrodes on top and bottom sensing layers, the possibility of alignment error across the touch panel surface is increased. The use of a planar electrode on one layer, e.g., the bottom electrode layer reduces the possibility of misalignment of upper and lower electrode arrays.

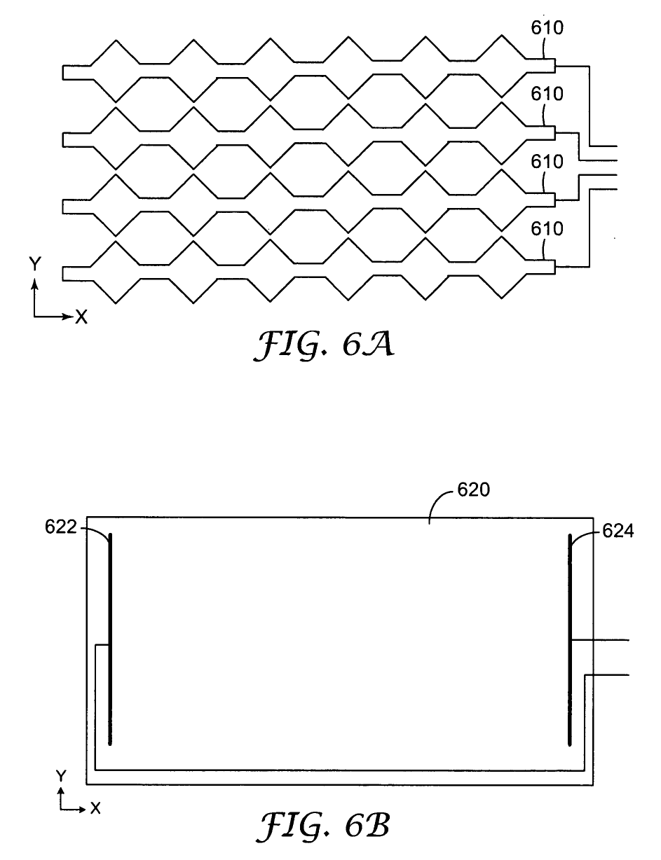

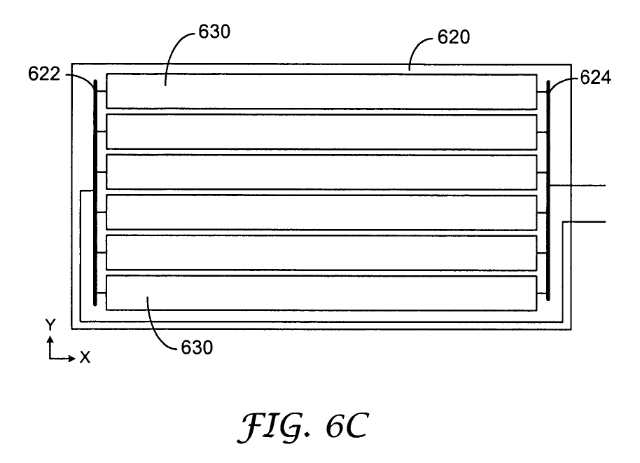

Some embodiments of the invention are directed to the use of an array of electrodes on one sensing layer and the use of a planar electrode on another sensing layer. Such configurations allow for reduced complexity in touch sensor fabrication. FIGS. 6A-C illustrate touch panel configurations that help to alleviate the alignment criticality for large area panels. The exemplary embodiment of FIGS. 6A and 6B uses an array of electrodes 610 on one sensing layer, illustrated in FIG. 6A, and a planar electrode 620 on a second sensing layer, illustrated in FIG. 6B. In a typical deployment, the touch panel is transparent and the electrodes 610, 620 are made of a transparent conductive material, such as ITO. In the example illustrated in FIGS. 6A and 6B, the longitudinal dimensions of the array electrodes 610 are arranged substantially parallel to the longer dimension (X axis) of the touch panel, to reduce the number of electrodes 610 that need to be multiplexed via the signal lines. The array of electrodes 610 is used to resolve the touch location with respect to the Y axis.

The second sensing layer comprises a planar electrode 620, illustrated in FIG. 6B having two connections 622, 624 at the edges of the planar electrode 620. The planar electrode is used to resolve the touch coordinates with respect to the X axis of the touch panel using a ratiometric process. The controller electronics (not shown) is connected to the planar electrode 620 through connections 622, 624. The controller drives the planar electrode 620 with an excitation signal. A signal responsive to a touch near or on the planar electrode 620 is measured by the controller electronics via connections 622, 624 at the left and right edges of the planar electrode 620. The amount of signal change caused by a touching object on or sufficiently near the planar electrode 620, and detected at connections 622, 624, depends on the amount of resistance between the touch point and the connections 622, 624. By taking the ratio of the signals detected at the edge connections 622, 624 the coordinate of the touch in the X direction can be determined.

The touch panel construction illustrated in FIGS. 6A and 6B significantly increases the tolerance of the touch panel to misalignment of the two electrode layers. Because the bottom layer electrode 620 is substantially isotropic in the XY plane, the alignment of the top electrodes 610 with respect to the bottom electrode 620 is less critical, as long as the position of the top layer array is confined between the electrode connections 622, 624 of the bottom layer. The relaxed alignment requirement provides for a higher manufacturing yield rate and cost reduction.

FIG. 6C illustrates a further embodiment, wherein the planar electrode 620 is divided into several wide rectangular electrodes 630. The right and left end of the electrodes 630 are connected to connectors 622, 624. This configuration directs most of the touch signal to connectors 622, 624 in a direction parallel to the longitudinal axis of the region 630 which is immediately under the touch. Using the electrodes 630 to direct the touch signal to connectors 622, 624 reduces the signal component perpendicular to the longitudinal axis of the regions 630, and increases the resolution of the sensor along the axis of the electrodes.

As previously discussed, a touch sensor may use a multiplexing scheme to reduce the number of signal lines required to connect the electrodes to the controller. If multiplexing is used, the phenomenon of “coordinate jump” can result in a large error in the reported touch coordinates. Coordinate jump is most prevalent in large touch panels where each signal line is shared by a number of electrodes. The signal lines are connected to the electrodes in a pattern wherein each electrode forms a unique arrangement of signal lines with its neighboring electrodes so that the electrodes sharing the same signal line can be distinguished from each other. When a touch occurs on or near an electrode, the controller resolves the touch location by determining the signal lines carrying the peak and a number of next strongest signals. The peak signal corresponds to the electrode most directly under the finger (designated the peak electrode), and the second and third strongest signals correspond to the electrodes that surround the peak electrode. The controller can identify the electrode closest to the touch by examining the arrangement of the signal lines corresponding to peak, and a number of next strongest signals.

For a given number of signal lines, the use of a discrete connection pattern to resolve touch location limits the size of a touch sensor. Larger touch sensors can only be fabricated by adding more signal lines. To relieve this constraint, a non-discrete connection pattern may be used. As described above, in implementations using non-discrete pattern, the controller resolves the touch location through analysis of the signal strength pattern on the signal lines exhibiting the largest signals. This process was previously described in connection with FIG. 3. The use of non-discrete connection pattern is based on the recognition that touches can only produce certain types of signal patterns. Thus, the electrodes of two or more neighborhoods can be connected to the same set of signal lines provided the arrangement of the electrode/signal lines connections within each neighborhood results in mutually exclusive signal patterns. Various aspects of touch sensors using discrete and non-discrete schemes are further described in commonly owned U.S. Pat. No. 6,825,833 which is incorporated herein by reference.

In touch sensors using multiplexing, a coordinate jump occurs when the controller incorrectly identifies the electrode neighborhood that includes the electrode nearest to the touch. For example, this phenomenon may occur when, due to certain hand configurations, the signals on the electrodes near the peak electrode resemble those of a different neighborhood. In this situation, the controller may misidentify the neighborhood of the peak electrode resulting in a large error in touch location. The coordinate jump phenomenon may be reduced through the use of additional signal lines and/or additional processing. However, increasing the number of signal lines and/or increasing the amount of processing may not be desirable.

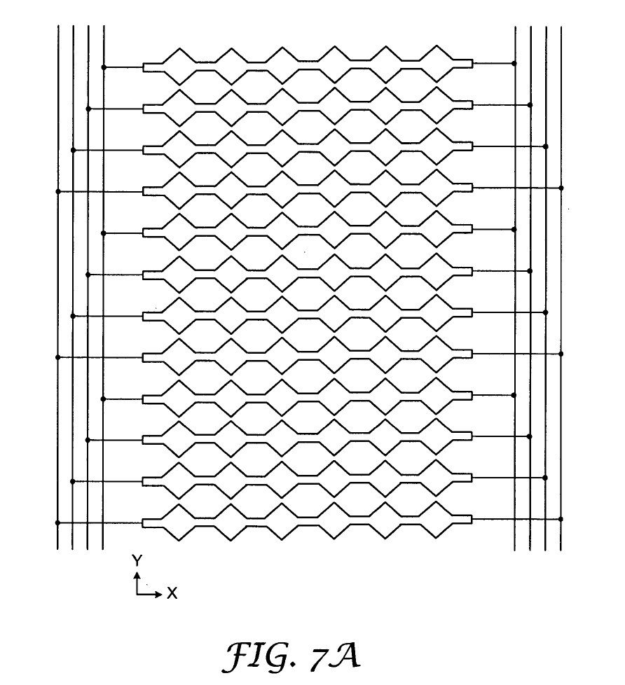

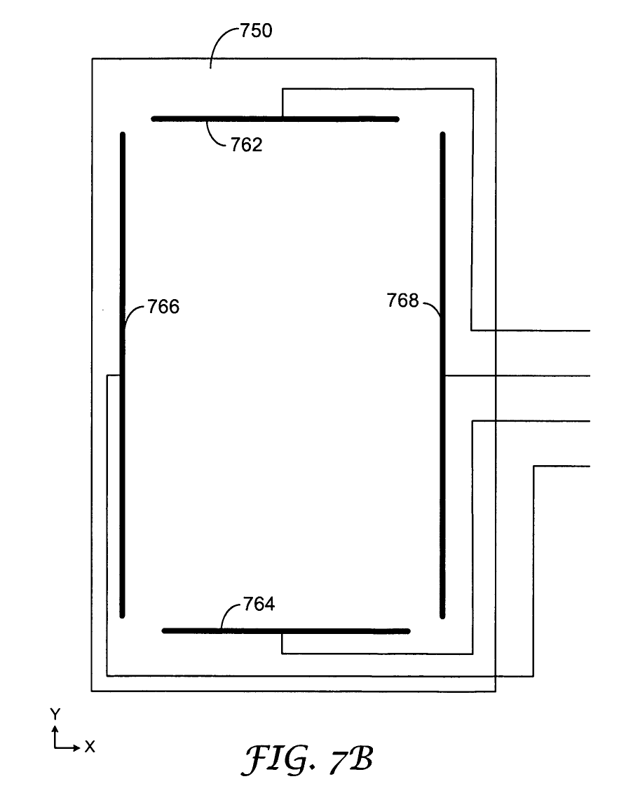

The use of an electrode array on one sensing layer and one or more planar electrodes on another sensing layer may be used to ameliorate the coordinate jump issue as well as to reduce the alignment criticality for large area touch panels. FIG. 7B illustrates a planar electrode 750 that may be used along with an electrode array, such as the array of substantially parallel electrodes 710 illustrated in FIG. 7A. Typically the planar electrode 750 is used as the bottom sensing layer and the array of electrodes 710 is used as the top sensing layer. FIG. 7A illustrates an electrode array having electrode/signal line connections arranged in a repeating pattern as previously described in connection with FIG. 2A, although other patterns may be used. For example, the electrode/signal line connections may be alternatively arranged according to various coding schemes, including the simple coding scheme described in connection with FIG. 4, or more extensive coding schemes as described, for example, in U.S. Pat. No. 6,825,833 which was previously incorporated herein.

The planar electrode of FIG. 7B uses four connections disposed along top, bottom, left, and right edges 762, 764, 766, 768. As previously described in connection with FIG. 6B, the left 766 and right 768 connections may be used to determine a location of a touch with respect to the X axis based on a ratio of the signal strengths responsive to the touch detected on the left 766 and right 768 connections.

The electrode array illustrated in FIG. 7A comprises 12 substantially parallel electrodes T71 -T712 having longitudinal axes arranged approximately in the X direction. In this embodiment, the electrodes T71-T712 have wider and narrower portions that increase capacitive coupling to the lower sensing layer when the electrode array of FIG. 7A is used as the top sensing layer, although electrodes of any geometry may be used. The left ends of top layer electrodes T71-T712 are connected to the controller (not shown) in a repeating pattern via signal lines TL71, TL72, TL73, TL74. The right ends of top layer electrodes T71-T712 are connected to the controller in a repeating pattern via signal lines TR71, TR72, TR73, TR74. The repeating pattern of the left end connections to signal lines TL71, TL72, TL73, TL74 exhibits mirror image symmetry with respect to the repeating pattern of the right end connections to signal line TR71, TR72, TR73, TR74, i.e., the top most electrode T71 is connected to signal line TL71 at the left end and to signal line TR71 at the right end. In one embodiment, all the signal lines are connected to the controller electronics through a cable running from the touch panel to the controller. The connections between electrodes T71-T712 and signal lines TL71-TL74 form a coded pattern as follows: TL71, TL72, TL73, TL74, TL71, TL72, TL73, TL74, TL71, TL72, TL73, TL74. The connections between electrodes T71-T712 and signal lines TR71-TR74 form a coded pattern as follows: TR71, TR72, TR73, TR74, TR71, TR72, TR73, TR74, TR71, TR72, TR73, TR74.

A touch to the touch panel in the vicinity of an electrode T71-T712 will create a signal at least on that electrode and also on adjacent electrodes. The strongest signal responsive to the touch will be observed on the electrode closest to the touch, with signals on electrodes farther from the touch exhibiting correspondingly smaller signals.

The process as described in the immediately preceding paragraph allows the controller to resolve a touch location with respect to the Y axis within a particular group of electrodes based on touch signals sensed using an array of electrodes T71-T712. However, because each signal line is connected to several of the electrodes T71-T712, the controller is unable to resolve the Y axis touch location among various groups of electrodes. The touch sensing system illustrated by FIGS. 7A and 7B may be configured to use the planar electrode 750 to resolve the ambiguity in the Y axis touch location, thus identifying the touch location to within a particular group of the electrodes T71-T712.

Identification of a particular group of the electrodes T71-T712 may be implemented through the previously described ratiometric process. The controller may determine the group of electrodes closest to the Y axis touch location by comparing the ratio of the signals responsive to a touch detected at top and bottom connections 762, 764. The controller may determine the X-axis touch location by comparing the ratio of signals responsive to the touch at left and right connections 766, 768.

As shown in FIGS. 6B and 7B, the planar electrode 620, 750 uses only two or four signal lines coupling the planar electrode 620, 750 to the controller. A touch panel may have only a certain number of signal lines available, and reducing the number of signal lines required for one electrode layer frees up additional signal lines for another electrode layer. Thus, the unused signal lines from the planar electrode layer may be used by the electrode layer having the electrode array, as illustrated in FIGS. 6A and 7A. For example, consider if only two connections are required for the planar electrode layer, with eight lines available for each layer. Six signal lines from the planar electrode layer are available to be used for the electrode array layer. Thus, the number of signal lines used for the electrode array layer is increased to 14. The availability of additional signal lines may be used to increase the number of unique signal arrangements, allowing larger area touch sensors to be fabricated using the same total number of signal lines. Alternatively, the sensor area can be kept the same, but the coding pattern may be made more robust against confusion between electrode groups, by using a greater number of signal lines for the electrode array.

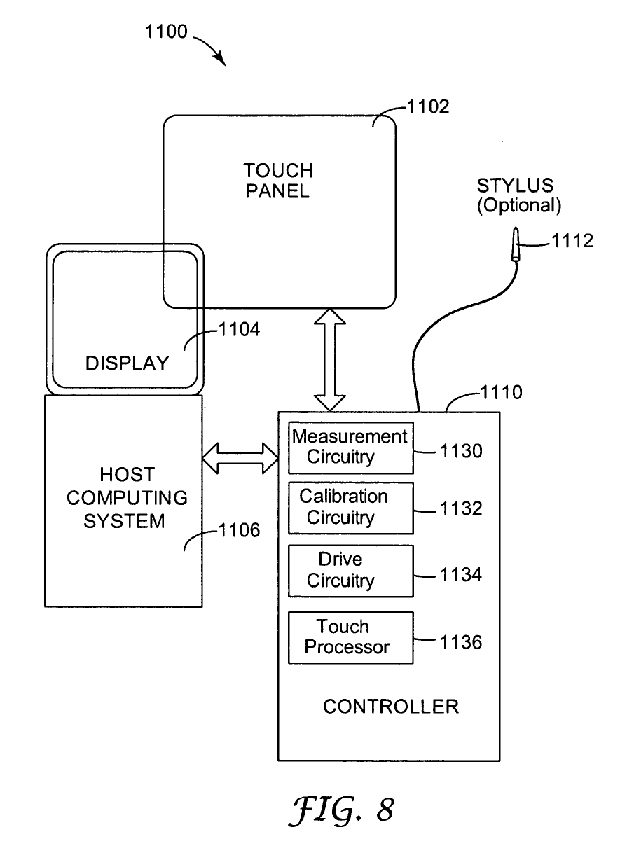

FIG. 8 illustrates a touch sensing system 1100 using a touch sensor configured to determine touch location in accordance with the principles of the present invention. The touch sensing system 1100 shown in FIG. 8 includes a touch panel 1102 having one or more arrays of electrodes which are connected to the touch measurement ports of a controller 1110 via signal lines. In a typical deployment configuration, the touch panel 1102 is used in combination with a display 1104 of a host computing system 1106 to provide for visual and tactile interaction between a user and the host computing system 1106. For example, the display 1104 may be visible through the touch panel 1102.

It is understood that the touch panel 1102 can be implemented as a device separate from, but operative with, a display 1104 of the host computing system 1106. Alternatively, the touch panel 1102 can be implemented as part of a unitary system which includes a display device, such as a plasma, LCD, or other type of display technology suitable for incorporation of the touch panel 1102. It is further understood that utility is found in a system defined to include only the touch panel 1102 and controller 1110 which, together, can implement a touch location determination methodology of the present invention.

In the illustrative configuration shown in FIG. 8, communication between the touch panel 1102 and the host computing system 1106 is effected via the controller 1110. It is noted that one or more controllers 1110 can be connected to one or more touch panels 1102 and the host computing system 1106. The controller 1110 is typically configured to execute firmware/software that provides for detection of touches applied to the touch panel 1102 by measuring signals on the electrodes of the touch panel 1102 in accordance with the principles of the present invention. It is understood that some of the functions and routines executed by the controller 1110 can alternatively be performed by additional digital or analog circuitry, for example adding or subtracting of signals or averaging of signals may be performed by analog circuits. It is understood that the functions and routines executed by the controller 1110 can alternatively be performed by a processor or controller of the host computing system 1106.

In one particular configuration, for example, the host computing system 1106 is configured to support an operating system and touch panel driver software. The host computing system 1106 can further support utility software and hardware. It will be appreciated that the various software/firmware and processing devices used to implement touch sensor processing and functionality can be physically or logically associated with the controller 1110, host computing system 1106, a remote processing system, or distributed amongst two or more of the controller 1110, host computing system 1106, and remote processing system.

The controller 1110 typically includes circuitry 1130 for measuring touch signals sensed using the electrodes and a touch processor 1136 configured to determine the location of the touch using touch signals generated by the electrodes. The touch sensing system 1100 may be used to determine the location of a touch by a finger, passive stylus or active stylus 1112. In applications that sense a finger touch or passive touch implement, the controller includes drive circuitry 1134 to apply an appropriate drive signal to the electrodes of the touch panel 1102. In some embodiments, circuitry 1130 for measuring the touch signals may be incorporated into the housing of the passive stylus. In systems using an active stylus 1112, the active stylus generates a signal that is transferred to the electrodes via capacitive coupling when the active stylus is near the surface of the touch sensor.

Some components of the controller 1110 may be mounted to a separate card that is removably installable within the host computing system chassis. Some components of the controller 1110, including drive circuitry 1134, calibration circuitry 1132, sensing or measurement circuitry 1130, including filters, sense amplifiers, AID converters, and/or other signal processing circuitry, may be mounted in or on a cable connecting the touch panel 1102 to the controller 1110.

The foregoing description of the various embodiments of the invention has been presented for the purposes of illustration and description. It is not intended to be exhaustive or to limit the invention to the precise form disclosed. Many modifications and variations are possible in light of the above teaching. For example, embodiments of the present invention may be implemented in a wide variety of applications. It is intended that the scope of the invention be limited not by this detailed description, but rather by the claims appended hereto.

What is claimed is:

1. A touch system, comprising:
a touch panel, comprising:
a first layer of one or more first electrodes electrically connected in an arrangement that produces a regional ambiguity in a touch location determined using the first electrodes with respect to a first axis; and
a second layer of one or more second electrodes configured to resolve the regional ambiguity of the touch location with respect to the first axis.

2. The touch system of claim 1, wherein:
the first electrodes are configured to be predominantly responsive to the touch location with respect to the first axis and less dominantly responsive to the touch location with respect to a second axis; and
the second electrodes are configured to be predominantly responsive to the touch location with respect to the second axis and less dominantly responsive to the touch location with respect to the first axis.

3. The touch system of claim 1, wherein:
the first electrodes comprise a first layer of substantially parallel electrodes; and
the second electrodes comprise a second layer of substantially parallel electrodes.

4. The touch system of claim 3, wherein a longitudinal axis of the first electrodes is substantially perpendicular to a longitudinal axis of the second electrodes.

5. The touch system of claim 1, wherein:
the second electrodes comprise a single electrode sheet; and
the first electrodes comprise a layer of substantially parallel electrodes.

6. The touch system of claim 1, wherein one or both of the first electrodes and the second electrodes comprise substantially parallel electrodes electrically connected in a discrete pattern.

7. The touch system of claim 1, wherein one or both of the first electrodes and the second electrodes comprise substantially parallel electrodes electrically connected in a non-discrete pattern.

8. The touch system of claim 1, wherein one or both of the first electrodes and the second electrodes comprise substantially parallel electrodes electrically connected in a repeating pattern.

9. The touch system of claim 1, wherein:
the arrangement of the first electrodes allows determination of the touch location using a non-ratiometric process; and
the arrangement of the second electrodes allows resolution of the regional ambiguity using a ratiometric process.

10. The touch system of claim 1, wherein:
the second electrodes are electrically connected in an arrangement that produces a regional ambiguity in a touch location determined using the second electrodes with respect to a second axis; and
the first electrodes are configured to resolve the regional ambiguity of the touch location with respect to the second axis.

11. The touch system of claim 1, further comprising a controller configured to receive touch signals generated using the first electrodes and touch signals generated using the second electrodes, to use the touch signals generated by the first electrodes to determine the touch location with respect to a first axis, and to use the touch signals generated using the second electrodes to resolve the regional ambiguity with respect to the first axis.

12. The touch system of claim 1, further comprising a display viewable through the touch panel.

13. A touch sensing method, comprising:
determining a touch location having a regional ambiguity with respect to a first axis of a touch panel using touch signals generated by one or more first electrodes; and
resolving the first axis regional ambiguity using touch signals generated by one or more second electrodes.

14. The method of claim 13, wherein:
the touch signals generated by the first electrodes are predominantly responsive to the touch location with respect to a first axis and are less dominantly responsive to the touch location with respect to a second axis; and
the touch signals generated by the second electrodes are predominantly responsive to the touch location with respect to the second axis and are less dominantly responsive to the touch location with respect to the first axis.

15. The method of claim 13, further comprising:
determining the touch location having a regional ambiguity with respect to a second axis of the touch panel using touch signals generated by the second layer of one or more second electrodes; and
resolving the second axis regional ambiguity using touch signals generated by the first layer of one or more first electrodes.

16. The method of claim 13, wherein:
the one or more first electrodes are disposed in a first layer of the touch panel; and
the one or more second electrodes are disposed in a second layer of the touch panel.

17. The method of claim 13, wherein:
determining the touch location using the touch signals generated by the first electrodes comprises determining the touch location using non-ratiometric touch signals; and
resolving the ambiguity in the touch location using the touch signal generated by the second electrodes comprises resolving the ambiguity in the touch location using ratiometric signals.

18. The method of claim 13, wherein:
determining the touch location using the touch signals generated by the first electrodes comprises determining the touch location using the touch signals generated by substantially parallel first electrodes; and
resolving the first axis regional ambiguity using touch signals generated by the second electrodes comprises resolving the first axis regional ambiguity using the touch signals generated by substantially parallel second electrodes.

19. The method of claim 13, wherein:
determining the touch location using the touch signals generated by the first electrodes comprises determining the touch location using the touch signals generated by substantially parallel first electrodes; and
resolving the first axis regional ambiguity using touch signals generated by the second electrodes comprises resolving the first axis regional ambiguity using the touch signals generated by a planar electrode.

20. The method of claim 13, wherein determining the touch location using the touch signals generated by the first electrodes comprises determining the touch location using the touch signals generated by the first electrodes which are substantially parallel and electrically connected in a discrete pattern.

21. The method of claim 13, wherein determining the touch location using the touch signals generated by the first electrodes comprises determining the touch location using the touch signals generated by the first electrodes which are substantially parallel and electrically connected in a non-discrete pattern.

22. The method of claim 13, wherein determining the touch location using the touch signals generated by the first electrodes comprises determining the touch location using the touch signals generated the by first electrodes which are substantially parallel and electrically connected in a repeating pattern.

23. A touch sensing system, comprising:
means for determining a touch location having a regional ambiguity with respect to a first axis of a touch panel using touch signals generated by one or more first electrodes; and
means for resolving the first axis regional ambiguity using touch signals generated by one or more second electrodes.

24. The touch sensing system of claim 23, further comprising:
means for determining the touch location having a regional ambiguity with respect to a second axis of the touch panel using touch signals generated by the second electrodes; and
means for resolving the second axis regional ambiguity using touch signals generated by the first electrodes.
